(19) United States
(12) Patent Application Publication
(10) Pub. No.: US 2018/0332372 A1
(43) Pub. Date: Nov. 15, 2018

(54) Optical Implementation of a Butler Matrix

(71) Applicant: Futurewei Technologies, Inc., Plano, TX (US)

(72) Inventors: Xiang Liu, Marlboro, NJ (US); Huiyuan Liu, Orlando, FL (US); Frank Effenberger, Frisco, TX (US)

(21) Appl. No.: 15/965,579

(22) Filed: Apr. 27, 2018

Related U.S. Application Data
(60) Provisional application No. 62/505,681, filed on May 12, 2017.

(51) Int. Cl. H04Q 11/00; H04B 10/50; H04B 10/54; H04B 10/516; H04B 10/2575; H01Q 3/26

(52) U.S. Cl. CPC H04Q 11/0005; H04B 10/504; H04B 10/541; H04B 10/5161; H04B 7/0413; H01Q 3/2676; H04B 2210/006; H04Q 2011/0058; H04B 10/25752

(57) ABSTRACT

A CO comprises a plurality of IM lasers and a Butler matrix system coupled to the plurality of IM lasers. The Butler matrix system comprises a plurality of optical input ports corresponding to the plurality of IM lasers, Butler matrix components coupled to the plurality of optical input ports, and a plurality of optical output ports coupled to the Butler matrix components and corresponding to the plurality of optical input ports. A method comprises generating an optical signal; receiving an analog electrical signal; modulating the analog electrical signal onto the optical signal using IM to create a modulated optical signal; and introducing, using a Butler matrix system, a phase shift to the modulated optical signal to create a phase-shifted modulated optical signal.

### CROSS-REFERENCE TO RELATED APPLICATIONS

This application claims priority to U.S. provisional patent application No. 62/505,681 filed on May 12, 2017 by Futurewei Technologies, Inc. and titled “Beamforming Using Optical Implementation of Butler Matrix,” which is incorporated by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Internet traffic is quickly increasing due to bandwidth-demanding services such as video streaming and multiple-device control. To access broader bandwidth in order to support such services in 5G, there is interest in using the millimeter waveband. Due to their short wavelengths, millimeter wavelength signals suffer from high path loss and low diffraction around obstacles. For that reason, the millimeter waveband is well suited for short distance transmission such as indoor transmission. To enable usage of the millimeter waveband for longer transmission distances and lower power consumption, various approaches such as MIMO beamforming and RoF PAAs are being considered.

### SUMMARY

In one embodiment, the disclosure includes a CO comprising: IM lasers; and a Butler matrix system coupled to the IM lasers and comprising: optical input ports, Butler matrix components coupled to the optical input ports, and optical output ports coupled to the Butler matrix components. In some embodiments, the IM lasers are DMLs or EMLs; the Butler matrix components comprise: a first hybrid coupler coupled to a first set of the optical input ports; a first PS coupled to the first hybrid coupler; and a second hybrid coupler coupled to the first PS and a first set of the optical output ports; the Butler matrix components further comprise: a third hybrid coupler coupled to a second set of the optical input ports and the second hybrid coupler; a second PS coupled to the third hybrid coupler; and a fourth hybrid coupler coupled to the first hybrid coupler, the second PS, and a second set of the optical output ports; the Butler matrix system is indirectly coupled to the IM lasers; the CO further comprises an optical switch coupled to the IM lasers and the Butler matrix system; the CO further comprises DACs coupled to the IM lasers; the CO further comprises a DSP coupled to the DACs; the CO further comprises a baseband unit BBU coupled to the DSP.

In another embodiment, the disclosure includes a method comprising: generating an optical signal; receiving an analog electrical signal; modulating the analog electrical signal onto the optical signal using IM to create a modulated optical signal; and introducing, using a Butler matrix system, a phase shift to the modulated optical signal to create a shifted optical signal. In some embodiments, the introducing the phase shift comprises: passing the modulated optical signal through a first hybrid coupler; and passing the modulated optical signal through a second hybrid coupler; the introducing the phase shift further comprises passing the modulated optical signal through a PS after the first hybrid coupler and before the second hybrid coupler; the passing the modulated optical signal through the first hybrid coupler introduces a 0° phase shift, passing the modulated optical signal through the PS introduces a 45° phase shift, and passing the modulated optical signal through the second hybrid coupler introduces a 90° phase shift for a total 135° phase shift; the shifted optical signal corresponds to an antenna in a MIMO beamforming scheme based on an amount of the phase shift; a CO in an RoF system implements the method.

In yet another embodiment, the disclosure includes a CO comprising: a Butler matrix system configured to: receive an optical signal, the optical signal comprising IM, and introduce a phase shift to the optical signal to create a shifted optical signal; and an optical switch coupled to the Butler matrix system, comprising an input port and an output port, and configured to direct the shifted optical signal from the input port to the output port. In some embodiments, the CO further comprises a detector coupled to the optical switch and configured to convert the shifted optical signal into a received analog electrical signal using DD; the CO further comprises an ADC coupled to the detector and configured to convert the received analog electrical signal into a digital electrical signal; the CO further comprises a DSP coupled to the ADC and configured to convert the digital electrical signal into a data stream; the optical signal corresponds to an antenna in a MIMO beamforming scheme.

Any of the above embodiments may be combined with any of the other above embodiments to create a new embodiment. These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an RoF system demonstrating a DL configuration according to an embodiment of the disclosure.

FIG. 2 is a schematic diagram of an RoF system demonstrating a UL configuration according to an embodiment of the disclosure.

FIG. 3 is a schematic diagram of a Butler matrix system according to an embodiment of the disclosure.

FIG. 4 is a schematic diagram of a Butler matrix system according to another embodiment of the disclosure.

FIG. 5 is a schematic diagram of a Butler matrix system according to yet another embodiment of the disclosure.

FIG. 6 is a flowchart illustrating a method of optically implementing a Butler matrix according to an embodiment of the disclosure.

FIG. 7 is a schematic diagram of an apparatus according to an embodiment of the disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The following abbreviations and initialisms apply:

ADC: analog-to-digital converter

ASIC: application-specific integrated circuit

BBU: baseband unit

CO: central office

CPU: central processing unit

DAC: digital-to-analog converter

DD: direct detection

DC: direct current

DL: downlink

DMD: digital micromirror device

DML: directly modulated laser

DSP: digital signal processor

EDFA: erbium-doped fiber amplifier

EML: electro-absorption modulated laser

EO: electrical-to-optical

FPGA: field-programmable gate array

IM: intensity-modulated, intensity modulation

MEMS: micro-electro-mechanical systems

MIMO: multiple-input and multiple-output

MZM: Mach-Zehnder modulator

OE: optical-to-electrical

OFDM: orthogonal frequency-division multiplexing

PAA: phased-array antenna

PIC: photonic integrated circuit

PIN: p-type, intrinsic, n-type

PS: phase shifter

RAM: random-access memory

RAN: radio access network

RF: radio frequency

RoF: radio over fiber

ROM: read-only memory

RRU: remote radio unit

RX: receiver unit

SRAM: static RAM

TCAM: ternary content-addressable memory

TX: transmitter unit

UE: user equipment

UL: uplink

WDM: wavelength-division multiplexer

3G: third generation

4G: fourth generation

5G: fifth generation

°: degree(s).

Various approaches to RoF systems implement MZMs to modulate optical signal phases, phase controllers to modulate optical signal phases, and IM-DD to modulate and detect optical signals. However, MZM systems are expensive and complex; phase controllers are expensive and complex; and prior IM-DD systems use a laser and a detector for each antenna, making those systems expensive and complex. There is therefore a desire for an RoF system that is less expensive and less complex.

Disclosed herein are embodiments for optical implementation of a Butler matrix. The embodiments comprise Butler matrix systems that introduce phase shifts to optical signals. The phase shifts correspond to antennae in a MIMO beamforming scheme. The optical signals are modulated with IM and detected with DD. Use of the Butler matrix system reduces a number of DACs and lasers used, thus reducing size, weight, and cost.

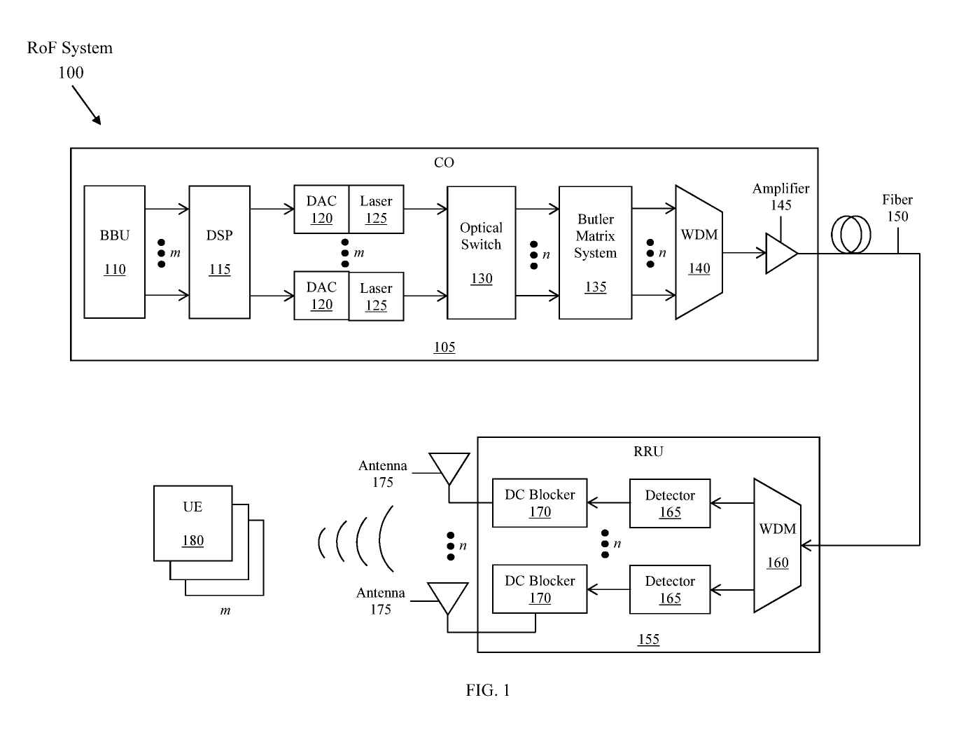

FIG. 1 is a schematic diagram of an RoF system 100 demonstrating a DL configuration according to an embodiment of the disclosure. The RoF system 100 generally comprises a CO 105, a fiber 150, an RRU 155 coupled to the CO 105 by the fiber 150, and up to m number of UEs 180. The m term is a positive integer, for instance sixteen in some examples. It should be understood that the CO 105 (and the BBU 110) may be communicatively coupled to one or more other devices or networks, such as infrastructure of a RAN, a fiber optic or cable network, or a packet network. A direction from the CO 105 to the RRU 155 (and the UEs 180) is referred to as a DL direction. A direction from the UEs 180 and the RRU 155 to the CO 105 is referred to as a UL direction.

The CO 105 comprises a BBU 110, a DSP 115 coupled to the BBU 110, m number of DACs 120 coupled to the DSP 115, m number of lasers 125 coupled to the m number of DACs 120, an optical switch 130 coupled to the m number of lasers 125, a Butler matrix system 135 coupled to the optical switch 130, a WDM 140 coupled to the Butler matrix system 135, and an amplifier 145 coupled to the WDM 140. The lasers 125 may be DMLs or EMLs in some embodiments and may operate at different wavelengths. The lasers 125 may use IM in some embodiments and thus be referred to as IM lasers. The optical switch 130 is an m×n optical switch in some embodiments and comprises m optical input ports and n optical output ports, for example. The n term is a positive integer, for instance four times the m term and thus 64 in some examples. A combination of input fibers, collimating lenses, a DMD, a Fourier lens, and output fibers may implement the optical switch 130. The Butler matrix system 135 comprises n optical input ports and n optical output ports in some embodiments, and is described below. Each of the m outputs of the BBU 110 is received in one of the n input ports of the Butler matrix system 135. The optical switch 130 maps the m BBU outputs to the n Butler matrix inputs. The amplifier 145 may be an EDFA in some embodiments.

The RoF system 100 shows a single fiber 150 coupling the CO 105 to the RRU 155. Alternatively, the RoF system 100 comprises multiple fibers coupling the CO 105 and the RRU 155. In some examples, the multiple fibers can comprise n number of fibers, and in that case, the RoF system 100 may not comprise the WDMs 140, 160. The multiple fibers may be in a fiber bundle.

The RRU 155 comprises a WDM 160, n number of detectors 165 coupled to the WDM 160, n number of DC blockers 170 coupled to the detectors 165, and n number of antennae 175 coupled to the DC blockers 170. The detectors 165 may be PIN diodes. The detectors 165 may use DD and thus be referred to as DD detectors. The DC blockers 170 may be digital filters. The UEs 180 are mobile phones or other devices and are associated with users.

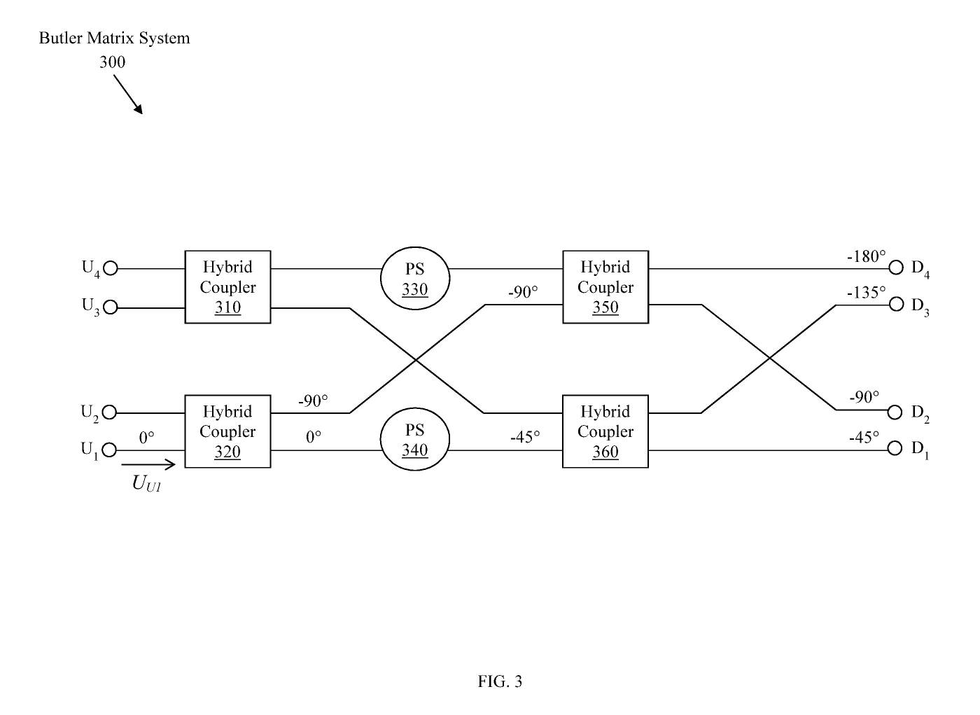

The RoF system 100 may be implemented as part of a wireless OFDM communication system. The UEs may communicate wirelessly with the RRU 155, such as via a 3G, 4G, or 5G telecommunications standard. The BBU 110 may generate a signal to be transmitted, or may be coupled to other devices, systems, or networks and may receive and relay the signal to be transmitted. The signal to be transmitted may comprise a digital electronic signal in some examples. The CO 105 can generate up to a maximum of m number of data streams for transmission to the m UEs 180. The BBU 110, together with the DSP 115, passes the signal to be transmitted to a DAC 120 of the m number of DACs 120, which converts the signal to an analog electrical signal. A laser 125 of the m number of lasers 125 generates a modulated optical signal that is modulated according to the analog electrical signal. The optical switch 130 provides the modulated optical signal to the Butler matrix system 135. The Butler matrix system 135 creates n number of modulated optical signal outputs at differing phase shifts (see discussion below for FIG. 3) for the received modulated optical signal. While a signal received at the Butler matrix system 135 will be received at a single input port, it should be understood that multiple signals can be received on multiple corresponding input ports at a given time. The WDM 140 multiplexes the n number of phase-shifted modulated optical signals (all at the same frequency but at different phases) into a serial optical data stream. The WDM 140 combines multiple signals at different wavelengths so the multiple signals can be transmitted together over the fiber 150. The serial optical data stream is transferred to the RRU 155 via the fiber 160, wherein the WDM 160 de-multiplexes the serial optical data stream into the parallel n number of phase-shifted modulated optical signals and provides them to the n number of detectors 165, which generates n number of phase-shifted electrical signals. The RRU 155 emits the n number of electrical signals using the n number of antennas 175. The n number of phase-shifted electrical signals are radiated by the n number of antennas 175 to generate a directional beam, wherein constructive and destructive interference by the radiation generates a substantially directional lobe or beam that is directed toward a corresponding UE 180. This is commonly known as beamforming.

In operation, in the CO 105, the BBU 110 provides one or more data streams to the DSP 115. The BBU 110 can provide up to m number of data streams to the DSP 115. For simplicity, one data stream intended for one UE 180 is discussed. The DSP 115 converts the data stream into a digital electrical signal. The DAC 120 converts the digital electrical signal into an analog electrical signal. The laser 125 generates an optical signal and modulates the analog electrical signal onto the optical signal using IM to create a modulated optical signal. The optical switch 130 switches the modulated optical signal from an optical input port of the optical switch 130 to a desired optical output port of the optical switch 130, then passes the modulated optical signal to a corresponding optical input port of the Butler matrix system 135. A MEMS component or another component may control the optical switch 130. The Butler matrix system 135 introduces a phase shift to the modulated optical signal to create a shifted optical signal, which may also be referred to as a phase-shifted modulated optical signal. The phase shift is based on the optical input port of the Butler matrix system 135 that is receiving the modulated optical signal. The Butler matrix system 135 passes the shifted optical signal from a corresponding optical output port of the Butler matrix system 135 to the WDM 140. The WDM 140 multiplexes the shifted optical signal with other shifted optical signals (if present) to create a combined optical signal. The amplifier 145 amplifies the combined optical signal to create an amplified optical signal and passes the amplified optical signal towards the RRU 155 over the fiber 150.

In the RRU 155, the WDM 160 demultiplexes the amplified optical signal to obtain a single received optical signal in this example, corresponding to the shifted optical signal from the Butler matrix system 135. A detector 165 converts the received optical signal into a received analog electrical signal using DD. A DC blocker 170 removes a DC component of the received analog electrical signal to create a DC-free analog electrical signal. Based on the DC-free analog electrical signal, an antenna 175 transmits a RF signal towards the UE 180. Multiple antennae 175 may do so to implement MIMO beamforming in some embodiments. In that case, each antenna 175 receives a different DC-free analog electrical signal corresponding to a different shifted optical signal from the Butler matrix system 135 and based on an amount of shift in each shifted optical signal. The UE 180 receives the RF signal, converts the RF signal into an electrical signal, and further processes the electrical signal.

As shown, the RoF system 100 uses m number of lasers 125 to implement n number of antennae 175. The RoF system 100 may do so because the Butler matrix system 135 creates, for each input optical signal, four output optical signals with different phase shifts for a total of up to n number of output optical signals. Thus, compared to other approaches, the RoF system 100 uses one-quarter of the number of DACs 120 and lasers 125. In addition, the use of IM and DD are simpler, and use less components, than other modulation and detection techniques. By reducing the number of components, the RoF system 100 reduces its size, weight, and cost. In addition, because the RoF system 100 uses optical modulation, its modulation is substantially immune to electromagnetic interference.

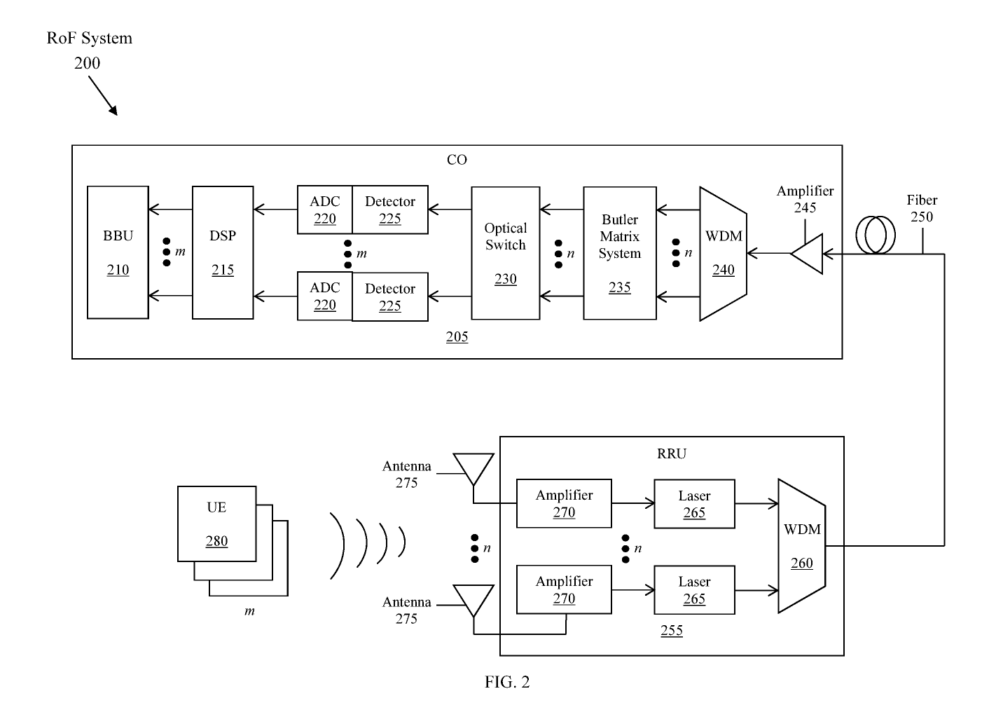

FIG. 2 is a schematic diagram of an RoF system 200 demonstrating a UL configuration according to an embodiment of the disclosure. The RoF system 200 is similar to the RoF system 100 in FIG. 1. Specifically, the RoF system 200 generally comprises a CO 205, a fiber 250 coupled to the CO 205, a RRU 255 coupled to the fiber 250, and one or more UEs 280 that can communicate wirelessly with the RRU 255. The RoF system 200 is similar to the CO 105, the fiber 150, the RRU 155, and the UEs 180, respectively, of the RoF system 100. In addition, the CO 205 comprises a BBU 210, a DSP 215 coupled to the BBU 210, an optical switch 230 coupled to the DSP 215, a Butler matrix system 235 coupled to the optical switch 230, a WDM 240 coupled to the Butler matrix system 235, and an amplifier 245 coupled to the WDM 240. The components of the RRU 255 are similar to the BBU 110, the DSP 115, the optical switch 130, the Butler matrix system 135, the WDM 140, and the amplifier 145, respectively, of the RRU 155. Furthermore, the RRU 255 comprises a WDM 260 and n number of antennae 275, which are similar to the WDM 160 and the antennae 175, respectively. The similar components may perform similar functions. However, unlike in the RoF system 100, the CO 205 further comprises m number of ADCs 220 and m number of detectors 225. The RRU 255 further comprises n number of lasers 265 and n number of amplifiers 270.

In operation, the UE 280 converts an electrical signal into a RF signal and transmits the RF signal towards the antenna 275 of the RRU 255. In the RRU 255, the antenna 275 receives the RF signal and converts the RF signal into an analog electrical signal. The amplifier 270 amplifies the analog electrical signal to create an amplified electrical signal. The laser 265 generates an optical signal and modulates the amplified electrical signal onto the optical signal using IM to create a modulated optical signal. The WDM 260 multiplexes the modulated optical signal with other modulated optical signals to create a combined optical signal and passes the combined optical signal towards the CO 205 over the fiber 250.

In the CO 205, the amplifier 245 amplifies the combined optical signal to create an amplified optical signal. The WDM 240 demultiplexes the amplified optical signal to obtain a received optical signal corresponding to the modulated optical signal from the laser 265, and passes the received and demultiplexed optical signal or signals to the Butler matrix system 235. The Butler matrix system 235 introduces a phase shift to the received optical signal to create a shifted optical signal. The phase shift is based on which optical input port of the Butler matrix system 235 receives the received optical signal. The Butler matrix system 235 then passes the shifted optical signal from a corresponding optical output port of the Butler matrix system 235 to the optical switch 230. The optical switch 230 switches the shifted optical signal from an optical input port of the optical switch 230 to a desired optical output port of the optical switch 230, then passes the shifted optical signal to a corresponding detector 225. The detector 225 converts the shifted optical signal into a received analog electrical signal using DD. The ADC 220 converts the received analog electrical signal into a digital electrical signal. The DSP 215 converts the digital electrical signal into a data stream. The BBU 210 further processes the data stream.

The RoF system 100 and the RoF system 200 may be combined into a single RoF system. In such an RoF system, the RoF system 100 provides DL functionality and the RoF system 200 provides UL functionality. Thus, the components of the COs 105, 205 may be in a single transceiver, and the components of the RRUs 155, 255 may be in a single transceiver. The UEs 180, 280 may be the same UE.

FIG. 3 is a schematic diagram of a Butler matrix system 300 according to an embodiment of the disclosure. The Butler matrix system 300 implements the Butler matrix systems 135, 235. Specifically, within the Butler matrix system 135, there may be m number of Butler matrix systems 300, one corresponding to each DAC 120 and laser 125. Similarly, within the Butler matrix system 235, there may be m number of Butler matrix systems 300 corresponding to each ADC 220 and detector 225.

The Butler matrix system 300 comprises UL ports U₁, U₂, U₃, U₄; hybrid couplers 310, 320, 350, 360; PSs 330, 340; and DL ports D₁, D₂, D₃, D₄. The UL ports U₁, U₂, U₃, U₄ couple to the optical output ports of the optical switches 130, 230. The UL ports U₁, U₂, U₃, U₄ are optical input ports in the Butler matrix system 135 and are optical output ports in the Butler matrix system 235. The DL ports D₁, D₂, D₃, D₄ couple to the WDMs 140, 240. The DL ports D₁, D₂, D₃, D₄ are optical output ports in the Butler matrix system 135 of FIG. 1; and are optical input ports in the Butler matrix system 235 of FIG. 2. The hybrid couplers 310, 320, 350, 360 and the PSs 330, 340 may be referred to as Butler matrix components. The hybrid couplers 310 320 in the embodiment shown are coupled to input (i.e., UL) port subsets, while the hybrid couplers 350 and 360 are coupled to output (i.e., DL) port subsets. In the example shown in the figure, the hybrid coupler 310 is coupled to an input port subset comprising UL ports U₃ and U₄, while the hybrid coupler 320 is coupled to an input port subset comprising UL ports U₁ and U₂. In the example shown in the figure, the hybrid coupler 350 is coupled to an output port subset comprising DL ports D₂ and D₄, while the hybrid coupler 360 is coupled to an output port subset comprising DL ports D₁ and D₃. The hybrid couplers 310, 320, 350, 360 and the PSs 330, 340 may be passive components, and may be on a single integrated optical circuit. Four 1×2 passive optical couplers and optical delay lines implement the hybrid couplers 310, 320, 350, 360, which produce a −90° phase shift. Optionally, the hybrid couplers 310, 320, 350, 360 implement free-space optics. Optical delay lines implement the PSs 330, 340, which produce a −45° phase shift. The optical delay lines in the hybrid couplers 310, 320, 350, 360 and the PSs 330, 340 have lengths as follows:

$$Δ L = \frac{Δ φ}{{n}_{g} ( \frac{2 π f}{c} )} \qquad ( 1 )$$

where ΔL is a difference in length between a first set of optical delay lines and a second set of optical delay lines, Δϕ is a relative phase shift between the first set of optical delay lines and the second set of optical delay lines, n_{g} is a group index of the optical delay lines, f is a frequency of an optical signal passing through the optical delay lines, and c is the speed of light in a vacuum. Thus, Δϕ is −90° for the hybrid couplers 310, 320, 350, 360, and Δϕ is 45° for the PSs 330, 340, although only phase shifts for a single input U1 is shown (see example discussed below).

In the DL direction, the Butler matrix system 300 has the following relationship between optical signals at the UL ports U₁, U₂, U₃, U₄ and optical signals at the DL ports D₁, D₂, D₃, D₄:

$$D = C * U \\ [ \begin{matrix}{D}_{{D}_{1}} \\ {D}_{{D}_{2}} \\ {D}_{{D}_{3}} \\ {D}_{{D}_{4}}\end{matrix} ] = [ \begin{matrix}{e}^{- j 45 °} & {e}^{- j 135 °} & {e}^{- j 90 °} & {e}^{- j 180 °} \\ {e}^{- j 90 °} & {e}^{- j 0 °} & {e}^{- j 225 °} & {e}^{- j 135 °} \\ {e}^{- j 135 °} & {e}^{- j 225 °} & {e}^{- j 0 °} & {e}^{- j 90 °} \\ {e}^{- j 180 °} & {e}^{- j 90 °} & {e}^{- j 135 °} & {e}^{- j 45 °}\end{matrix} ] [ \begin{matrix}{U}_{{U}_{1}} \\ {U}_{{U}_{2}} \\ {U}_{{U}_{3}} \\ {U}_{{U}_{4}}\end{matrix} ] \qquad ( 2 )$$

where D represents optical signals at the DL ports D₁, D₂, D₃, D₄; C is a scattering matrix of the Butler matrix system 300; and U represents optical signals at the UL ports U₁, U₂, U₃, U₄. FIG. 3 shows phase shifts for an optical signal entering the UL port U₁, traveling in a DL direction, and exiting the DL ports D₁, D₂, D₃, D₄. As shown, a first optical signal U_{U}_{₁} enters the UL port U₁ with a 0° phase shift. The first optical signal passes through the hybrid coupler 320 and splits into the first optical signal with a 0° phase shift and a second optical signal with a −90° phase shift. The first optical signal passes through the PS 340 and undergoes a −45° phase shift. The first optical signal passes through the hybrid coupler 360 and splits into the first optical signal with a −45° phase shift and a third optical signal with a −135° phase shift. At the same time, the second optical signal passes through the hybrid coupler 350 and splits into the second optical signal with a −90° phase shift and a fourth optical signal with a −180° phase shift. The first optical signal exits the DL port D₁ as D_{D}_{₁} with a −45° phase shift, the second optical signal exits the DL port D₂ as D_{D}_{₂} with a −90° phase shift, the third optical signal exits the DL port D₃ as D_{D}_{₃} with a −135° phase shift, and the fourth optical signal exits the DL port D₄ as D_{D}_{₄} with a −180° phase shift.

For a DL transmission, where only U_{U}_{₁} is input into the Butler matrix system 135 of the CO 105 (see FIG. 1), the four resulting phase-shifted outputs at the DL ports D₁-D₄ can be multiplexed together by the WDM 240 for transmission over the fiber 250 to the RRU 155.

In the UL direction, the Butler matrix system 300 has the following relationship between optical signals at the UL ports U₁, U₂, U₃, U₄ and optical signals at the DL ports D₁, D₂, D₃, D₄:

$$U = {C}^{T} * D \\ [ \begin{matrix}{U}_{{U}_{1}} \\ {U}_{{U}_{2}} \\ {U}_{{U}_{3}} \\ {U}_{{U}_{4}}\end{matrix} ] = [ \begin{matrix}{e}^{- j 45 °} & {e}^{- j 90 °} & {e}^{- j 135 °} & {e}^{- j 180 °} \\ {e}^{- j 135 °} & {e}^{- j 0 °} & {e}^{- j 225 °} & {e}^{- j 90 °} \\ {e}^{- j 90 °} & {e}^{- j 225 °} & {e}^{- j 0 °} & {e}^{- j 135 °} \\ {e}^{- j 180 °} & {e}^{- j 135 °} & {e}^{- j 90 °} & {e}^{- j 45 °}\end{matrix} ] [ \begin{matrix}{D}_{{D}_{1}} \\ {D}_{{D}_{2}} \\ {D}_{{D}_{3}} \\ {D}_{{D}_{4}}\end{matrix} ] \qquad ( 3 )$$

where U is the same as in equation 2, C^{T} is a transpose matrix of C in equation 2, and D is the same as in equation 2. A generic optical signal D undergoing IM, traveling in a UL direction, and entering a DL port D₁, D₂, D₃, or D₄ may be represented as follows:

D=[1+mₑ cos(wₑt)]I₀ (4)

where mₑ is a modulation amplitude, wₑ is an angular frequency of the RF signal, t is a time, and I₀ is an average signal intensity. Thus, the resulting U_{D}_{₁} and U_{D}_{₁} are represented as follows:

$$\begin{matrix}\begin{matrix}{U}_{{D}_{1}} = [ 1 + {m}_{e} cos ( {w}_{e} t - 90 ° ) ] {I}_{0} + [ 1 + {m}_{e} cos ( {w}_{e} t - 180 ° ) ] {I}_{0} + \\ [ 1 + {m}_{e} cos ( {w}_{e} t - 270 ° ) ] {I}_{0} + [ 1 + {m}_{e} cos ( {w}_{e} t ) ] {I}_{0} \\ = 4 {I}_{0}\end{matrix} & ( 5 ) \\ \begin{matrix}{U}_{{D}_{4}} = [ 1 + {m}_{e} cos ( {w}_{e} t - 225 ° ) ] {I}_{0} + [ 1 + {m}_{e} cos ( {w}_{e} t - 225 ° ) ] {I}_{0} + \\ [ 1 + {m}_{e} cos ( {w}_{e} t - 225 ° ) ] {I}_{0} + [ 1 + {m}_{e} cos ( {w}_{e} t - 225 ° ) ] {I}_{0} \\ = 4 [ 1 + {m}_{e} cos ( {w}_{e} t - 225 ° ) ] {I}_{0}\end{matrix} & ( 6 )\end{matrix}$$

As shown, U_{D}_{₁} has only a non-time-varying component. The U_{D}_{₂} and U_{D}_{₃} terms similarly have only non-time-varying components. In contrast, the U_{D}_{₄} term has a time-varying component that contains a signal intended for transmission.

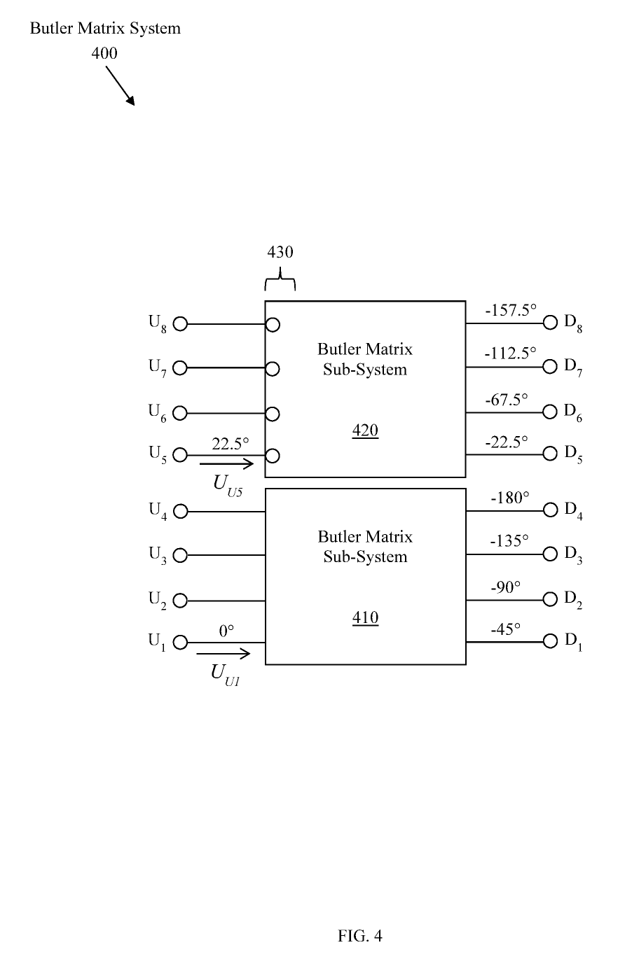

FIG. 4 is a schematic diagram of a Butler matrix system 400 according to another embodiment of the disclosure. The Butler matrix system 400 may be referred to as a one-dimensional cascade system. The Butler matrix system 400 comprises Butler matrix sub-systems 410, 420. However, the Butler matrix system 400 may comprise any suitable number of Butler matrix sub-systems. In addition, the Butler matrix sub-systems 410, 420 may comprise any suitable number of UL ports and DL ports and corresponding hybrid couplers and PSs. The Butler matrix sub-system 410 is similar to the Butler matrix system 300 in FIG. 3. Specifically, the Butler matrix sub-system 410 comprises UL ports U₁, U₂, U₃, U₄ and DL ports D₁, D₂, D₃, D₄. In addition, the Butler matrix sub-system 410 comprises hybrid couplers and PSs, which are not shown, in the same configuration as the Butler matrix system 300. Furthermore, when a first optical signal U_{U}_{₁} enters the UL port U₁ with a 0° phase shift, the first optical signal exits the DL port D₁ as D_{D}_{₁} with a −45° phase shift, a second optical signal exits the DL port D₂ as D_{D}_{₂} with a −90° phase shift, a third optical signal exits the DL port D₃ as D_{D}_{₃} with a −135° phase shift, and a fourth optical signal exits the DL port D₄ as D_{D}_{₄} with a −180° phase shift.

The Butler matrix sub-system 420 is also similar to the Butler matrix system 300 in FIG. 3. Specifically, the Butler matrix sub-system 420 comprises UL ports U₅, U₆, U₇, U₈ and DL ports D₅, D₆, D₇, D₈. In addition, the Butler matrix sub-system 420 comprises hybrid couplers and PSs, which are not shown, in the same configuration as the Butler matrix system 300. However, unlike in the Butler matrix system 300, a fifth optical signal U_{U}_{₅} enters the UL port U₅ with a 22.5° phase shift, the fifth optical signal exits the DL port D₅ as D_{D}_{₅} with a −22.5° phase shift, a sixth optical signal exits the DL port D₆ as D_{D}_{₆} with a −67.5° phase shift, a seventh optical signal exits the DL port D₇ as D_{D}_{₇} with a −112.5° phase shift, and an eighth optical signal exits the DL port D₈ as D_{D}_{₈} with a −157.5° phase shift. To accomplish the 22.5° phase shift for the first optical signal, the Butler matrix sub-system 420 may comprise a PS 430 at each UL port U₅, U₆, U₇, U₈ before the hybrid couplers, or alternatively may be included at the input ports U₅-U₈.

A Butler matrix system may be designed based on a needed number of hybrid couplers and a number of PSs. A Butler matrix system of size n×n (as in the Butler matrix system 300) comprises

$$\frac{n}{2} {log}_{2} n$$

hybrid couplers and

$$\frac{n}{2} ( {log}_{2} n - 1 ) PSs .$$

However, cascading the Butler matrix sub-systems, as in the Butler matrix system 400, reduces the number of hybrid couplers and PSs. For example, when n=8 and x=1, a Butler matrix system like the Butler matrix system 300, but with 8 UL ports and 8 DL ports, comprises 12 hybrid couplers. In contrast, when n=4 and x=2, the Butler matrix system 400 comprises 8 hybrid couplers.

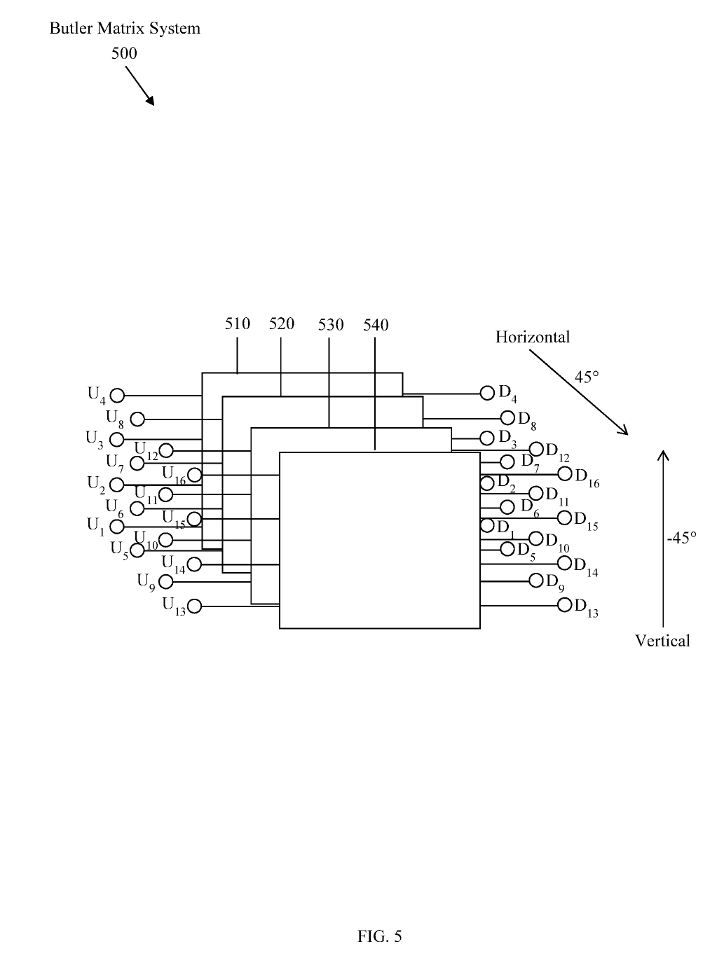

FIG. 5 is a schematic diagram of a Butler matrix system 500 according to yet another embodiment of the disclosure. The Butler matrix system 500 may be referred to as a two-dimensional cascade system. The Butler matrix system 500 comprises Butler matrix sub-systems 510, 520, 530, 540. The Butler matrix sub-systems 510, 520, 530, 540 are similar to the Butler matrix system 300 in FIG. 3. Specifically, the Butler matrix sub-systems 510, 520, 530, 540 comprise four UL ports and four DL ports. However, unlike in the Butler matrix system 300, optical signals entering and exiting the Butler matrix sub-systems 510, 520, 530, 540 have the following phase shifts:

| | 510 | 520 | 530 | 540 |
|---|---|---|---|---|
| first UL port | 0° | 45° | 90° | 135° |
| first DL port | −45° | 0° | 45° | 90° |
| second DL port | −90° | −45° | 0° | 45° |
| third DL port | −135° | −90° | −45° | 0° |
| fourth DL port | −180° | −135° | −90° | −45° |

As can be seen, the phase shifts increase by 45° in a horizontal direction in the figure, across the Butler matrix sub-systems 510, 520, 530, 540 and decrease by 45° in a vertical direction as a DL port number increases.

Though the Butler matrix system 400 comprises two Butler matrix sub-systems 410, 420 and the Butler matrix system 500 comprises four Butler matrix sub-systems 510, 520, 530, 540, the Butler matrix systems 400, 500 may comprise any suitable number of Butler matrix sub-systems. Though the Butler matrix system 300 and the Butler matrix sub-systems 410, 420, 510, 520, 530, 540 comprise four UL ports and four DL ports, the Butler matrix system 300 and the Butler matrix sub-systems 410, 420, 510, 520, 530, 540 may comprise any suitable number of UL ports and DL ports and corresponding hybrid couplers and PSs. Though the Butler matrix systems 300, 400, 500 are shown as implementing specific phase shifts, the Butler matrix systems 300, 400, 500 may implement any suitable phase shifts. The Butler matrix systems 300, 400, 500 may be fabricated as part of PICs.

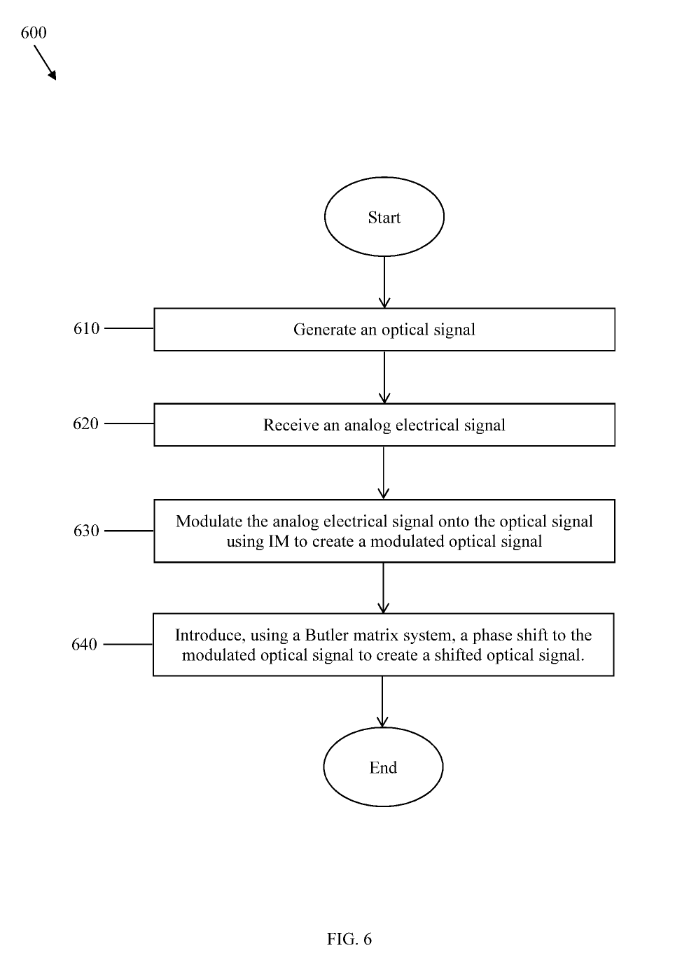

FIG. 6 is a flowchart illustrating a method 600 of optically implementing a Butler matrix according to an embodiment of the disclosure. The method 600 comprises communications in an UL direction and UL components, for instance the components in the CO 105, implement the method 600. At step 610, an optical signal is generated. For instance, the laser 125 generates the optical signal. At step 620, an analog electrical signal is received. For instance, the laser 125 receives the analog electrical signal. At step 630, the analog electrical signal is modulated onto the optical signal using IM to create a modulated optical signal. For instance, the laser 125 creates the modulated optical signal. Finally, at step 640, a Butler matrix system introduces a phase shift to the modulated optical signal to create a shifted optical signal. For instance, the Butler matrix system 135 introduces the phase shift.

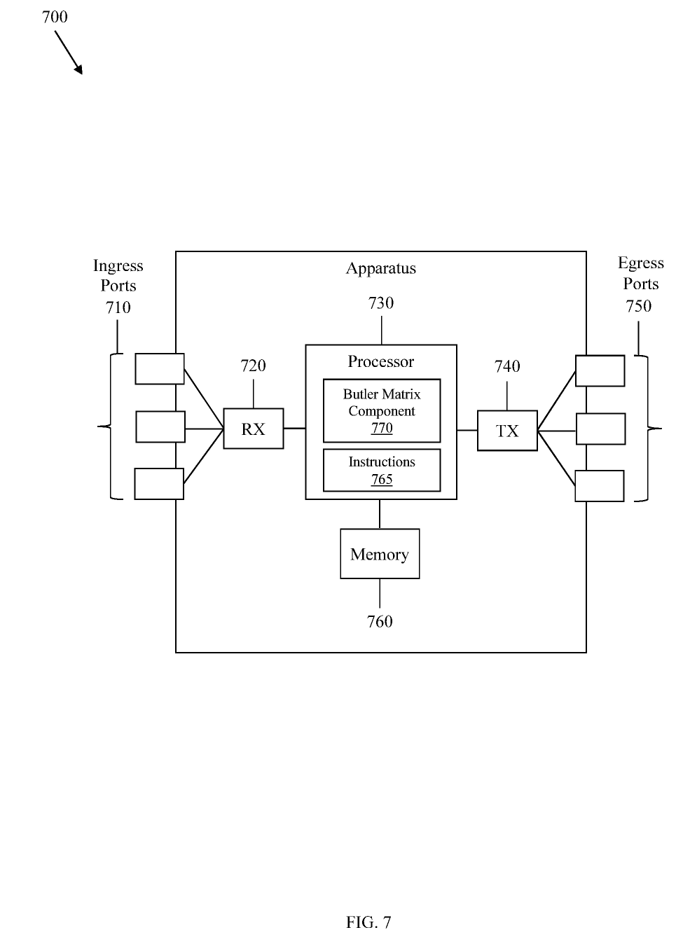

FIG. 7 is a schematic diagram of an apparatus 700 according to an embodiment of the disclosure. The apparatus 700 may implement the disclosed embodiments. The apparatus 700 comprises ingress ports 710 and an RX 720 coupled to the ingress ports 710 for receiving data; a processor, logic unit, baseband unit, or CPU 730 coupled to the RX 720 to process the data; a TX 740 coupled to the processor 730, egress ports 750 coupled to the TX 740 for transmitting the data; and a memory 760 coupled to the processor 730 for storing the data. The memory 760 in some embodiments stores instructions 765. The apparatus 700 may also comprise OE components, EO components, or RF components coupled to the ingress ports 710, the RX 720, the TX 740, and the egress ports 750 for ingress or egress of optical, electrical signals, or RF signals.

The processor 730 is any combination of hardware, middleware, firmware, or software. The processor 730 comprises any combination of one or more CPU chips, cores, FPGAs, ASICs, or DSPs. The processor 730 communicates with the ingress ports 710, the RX 720, the TX 740, the egress ports 750, and the memory 760. The processor 730 implements a Butler matrix component 770, implementing the disclosed embodiments. The inclusion of the Butler matrix component 770 therefore provides a substantial improvement to the functionality of the apparatus 700 and effects a transformation of the apparatus 700 to a different state. Alternatively, the memory 760 stores the Butler matrix component 770 as instructions, and the processor 730 executes those instructions.

The memory 760 comprises any combination of disks, tape drives, or solid-state drives. The apparatus 700 may use the memory 760 as an over-flow data storage device to store programs when the apparatus 700 selects those programs for execution and to store instructions and data that the apparatus 700 reads during execution of those programs. The memory 760 may be volatile or non-volatile and may be any combination of ROM, RAM, TCAM, or SRAM.

In an example embodiment, a CO comprises IM laser elements and a Butler matrix system element coupled to the IM laser elements. The Butler matrix system element comprises optical input port elements, Butler matrix component elements coupled to the optical input port elements, and optical output port elements coupled to the Butler matrix component elements.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A central office (CO) comprising:
a plurality of intensity-modulation (IM) lasers; and
a Butler matrix system coupled to the plurality of IM lasers and comprising:
a plurality of optical input ports corresponding to the plurality of the IM lasers,
Butler matrix components coupled to the plurality of the optical input ports, and
a plurality of optical output ports coupled to the Butler matrix components and corresponding to the plurality of the optical input ports.

2. The CO of claim 1, wherein the plurality of the IM lasers are directly modulated lasers (DMLs) or electro-absorption modulated lasers (EMLs).

3. The CO of claim 1, wherein the Butler matrix components comprise:
a first hybrid coupler coupled to a first input port subset of the plurality of the optical input ports;
a first phase shifter (PS) coupled to the first hybrid coupler; and
a second hybrid coupler coupled to the first PS and to a first output port subset of the plurality of the optical output ports.

4. The CO of claim 3, wherein the Butler matrix components further comprise:
a third hybrid coupler coupled to a second input port subset of the plurality of optical the input ports and to the second hybrid coupler;
a second PS coupled to the third hybrid coupler; and
a fourth hybrid coupler coupled to the first hybrid coupler, to the second PS, and to a second output port subset of the plurality of the optical output ports.

5. The CO of claim 1, wherein the Butler matrix system is indirectly coupled to the plurality of the IM lasers.

6. The CO of claim 5, further comprising an optical switch coupled to the plurality of the IM lasers and to the Butler matrix system.

7. The CO of claim 6, further comprising a plurality of digital-to-analog converters (DACs) coupled to the plurality of the IM lasers.

8. The CO of claim 7, further comprising a digital signal processor (DSP) coupled to the plurality of the DACs.

9. The CO of claim 8, further comprising a baseband unit (BBU) coupled to the DSP.

10. A method comprising:
generating an optical signal;
receiving an analog electrical signal;
modulating the analog electrical signal onto the optical signal using intensity modulation (IM) to create a modulated optical signal; and
introducing, using a Butler matrix system, a phase shift to the modulated optical signal to create a phase-shifted modulated optical signal.

11. The method of claim 10, wherein the introducing the phase shift comprises:
passing the modulated optical signal through a first hybrid coupler; and
passing the modulated optical signal through a second hybrid coupler.

12. The method of claim 11, wherein the introducing the phase shift further comprises passing the modulated optical signal through a phase shifter (PS) after the first hybrid coupler and before the second hybrid coupler.

13. The method of claim 12, wherein the passing the modulated optical signal through the first hybrid coupler introduces a 0° phase shift, passing the modulated optical signal through the PS introduces a 45° phase shift, and passing the modulated optical signal through the second hybrid coupler introduces a 90° phase shift for a total 135° phase shift.

14. The method of claim 10, wherein the phase-shifted modulated optical signal corresponds to an antenna in a multiple-input and multiple-output (MIMO) beamforming scheme based on an amount of the phase shift.

15. The method of claim 10, wherein a central office (CO) in a radio over fiber (RoF) system implements the method.

16. A central office (CO) comprising:
a Butler matrix system configured to:
receive an intensity-modulated (IM) optical signal, and
phase shift the IM optical signal to create a phase-shifted modulated optical signal; and
an optical switch coupled to the Butler matrix system, comprising an input port and an output port, and configured to direct the shifted optical signal from the input port of the optical switch to the output port of the optical switch.

17. The CO of claim 16, further comprising a detector coupled to the optical switch and configured to convert the phase-shifted modulated optical signal into a received analog electrical signal using direct detection (DD).

18. The CO of claim 17, further comprising an analog-to-digital converter (ADC) coupled to the detector and configured to convert the received analog electrical signal into a digital electrical signal.

19. The CO of claim 18, further comprising a digital signal processor (DSP) coupled to the ADC and configured to convert the digital electrical signal into a data stream.

20. The CO of claim 16, wherein the optical signal corresponds to an antenna in a multiple-input and multiple-output (MIMO) beamforming scheme.
